(19) United States
(12) Patent Application Publication
(10) Pub. No.: US 2013/0036738 A1
(43) Pub. Date: Feb. 14, 2013

(54) TURBOMACHINE FUELING SYSTEM WITH JET PUMP

(71) Applicant: Loic Pora, Champagne Sur Seine (FR)

(72) Inventor: Loic Pora, Champagne Sur Seine (FR)

(73) Assignee: SNECMA, Paris (FR)

(21) Appl. No.: 13/641,775

(22) PCT Filed: Apr. 21, 2011
(86) PCT No.: PCT/FR2011/050928

§ 371 Date: Oct. 17, 2012

(30) Foreign Application Priority Data
Apr. 28, 2010 (FR) 1053246

(51) Int. Cl. F02C 7/236

(52) U.S. Cl. 60/734

(57) ABSTRACT

A fuel supply assembly supplying a combustion chamber of a turbomachine with fuel and pressurizing the fuel, including: a first pump that pressurizes fuel drawn from tanks of an aircraft; a second pump that raises pressure beyond an outlet pressure of the first pump, and that provides constant fuel delivery, some of fuel leaving the second pump being sent to the combustion chamber via a direct circuit, the part of fuel not sent to the combustion chamber being recirculated, via a recirculation circuit, to upstream of the second pump; a hydraulic unit metering delivery to be injected into the combustion chamber of the turbomachine by a metering device on the direct circuit and at least one heat exchanger through which the fuel passes. The exchanger is positioned in a direct circuit downstream of the point at which the recirculation circuit branches off and upstream of the fuel metering device.

The present invention relates to the field of turbine engines, and more specifically to the field of equipment for supplying fuel to these turbine engines.

Conventionally, an aeronautical turbine engine carries a certain number of devices such as a low pressure pump (LP pump) and a high pressure pump (HP pump), filters, check valves, a regulating valve, and the like, which are fastened to the outer casing and which have the function of supplying fuel to the combustion chamber at the correct pressure and at the correct flow rate.

The fuel circuit is composed, in the first place, of a low pressure centrifugal pump, boosted upstream by a pump located in the aircraft part of the circuit, which provides the pressure level required at the inlet for the correct operation of the high pressure pump. The latter, which raises the pressure to the level required for the injection of the fuel into the combustion chamber of the turbine engine, is usually a constant delivery centrifugal pump, which delivers the same fuel flow rate at its outlet regardless of the engine speed. Between the high pressure pump and the injectors of the combustion chamber, there is a valve, or metering device, for controlling the injected flow rate, which adjusts the flow rate sent to the injectors to the flow rate providing the turbine engine speed desired by the pilot. The excess fuel is sent to a point upstream of the high pressure pump by what is known as a recirculation circuit or loop.

The fuel pumped into the tanks also passes through exchangers, where it recovers heat from other fluids used in the aircraft, such as the engine bearing lubricating oil or the hydraulic fluid which drives the actuators of the movable control surfaces of the aircraft. As a general rule, these exchangers are placed upstream of the high pressure pump to prevent them from operating at high pressures, thus allowing them to be simpler and cheaper to produce.

One of the disadvantages encountered with conventional fuel circuits is the presence of a centrifugal low pressure pump, which has rotating parts and therefore has a reliability which is determined by the life of these parts. It would be advantageous to be able to dispense with these rotating parts and use ejector pumps or jet pumps, which use the Venturi effect to draw in fuel from the aircraft circuit. In these pumps, a fluid is sent under pressure into an intake chamber where it is converted into a high-speed flow, which reduces its pressure, thus creating a partial vacuum which draws in the fuel from the aircraft. The fuel is then driven together with the driving fluid at a pressure which is greater than its initial pressure, but less than the pressure of the driving fluid. The simple design of these jet pumps, which have no moving parts, provides very high reliability, while no lubrication and very little maintenance are required.

However, the use of these pumps, where the recirculation fuel is used as the driving fluid, is subject to limitations arising from the temperature of the fuel, because they operate at pressures close to the saturated vapor pressure of the driving fluid which they use. This fluid must therefore be relatively cold in order to prevent it from vaporizing spontaneously when its pressure is reduced.

The object of the present invention is to overcome these drawbacks by proposing a fuel circuit in which the low pressure fuel supply can be provided by a pump operating without any rotating parts and with a fluid at the lowest possible temperature.

For this purpose, the invention proposes an assembly for supplying the combustion chamber of a turbine engine with fuel and for pressurizing the fuel, comprising at least a first pump for pressurizing the fuel drawn from the tanks of the aircraft and a second pump for raising the pressure above the outlet pressure of said first pump, said second pump being a constant fuel delivery pump, some of the fuel leaving this pump being sent to the combustion chamber via a direct circuit, the part of the fuel that is not sent to the combustion chamber being recirculated via a recirculation circuit upstream of said second pump, said assembly further including a hydraulic unit for metering the flow to be injected into the combustion chamber of the turbine engine by means of a metering device located in the direct circuit and at least one heat exchanger in which the fuel flows, characterized in that said exchanger is positioned in the direct circuit downstream of the branching point of the recirculation circuit and upstream of the fuel metering device.

By positioning the exchangers downstream of the fuel branch and upstream of the metering device, the heating of the recirculated fuel can be prevented, and thus the fuel can be used as the driving fluid in a jet pump while its temperature is kept as low as possible, thereby providing optimal pump operation because of the low saturated vapor pressure. This also prevents possible malfunctions of the hydraulic control unit which might be caused by a very low fuel temperature.

Preferably, the first pump is a jet pump which has no rotating parts. In this way, the desired object of substantially increasing the reliability of this element of the fuel circuit is achieved.

Advantageously, the driving fluid of the jet pump is composed of the recirculated fuel.

In a variant embodiment, the first pump is a jet pump with a variable cross section. A pump of this type enables the flow rate and pressure of the LP pump to be adapted in a more satisfactory way, thereby optimizing the recovery of the energy contributed by the recirculation fluid.

In a particular embodiment, the size of the variable cross section is controlled by a piston whose position in its cylinder is a function of the pressures in the fuel circuit immediately upstream and downstream of the metering device.

The invention also relates to a turbine engine including a fuel supply and pressurization assembly as described above, and also to an aircraft fitted with at least one such turbine engine.

The invention will be made more comprehensible, and other objects, details, features and advantages thereof will be clarified, by the following detailed explanatory description of one or more embodiments of the invention, provided as purely illustrative and non-limiting examples, with reference to the attached schematic drawings.

In these drawings:

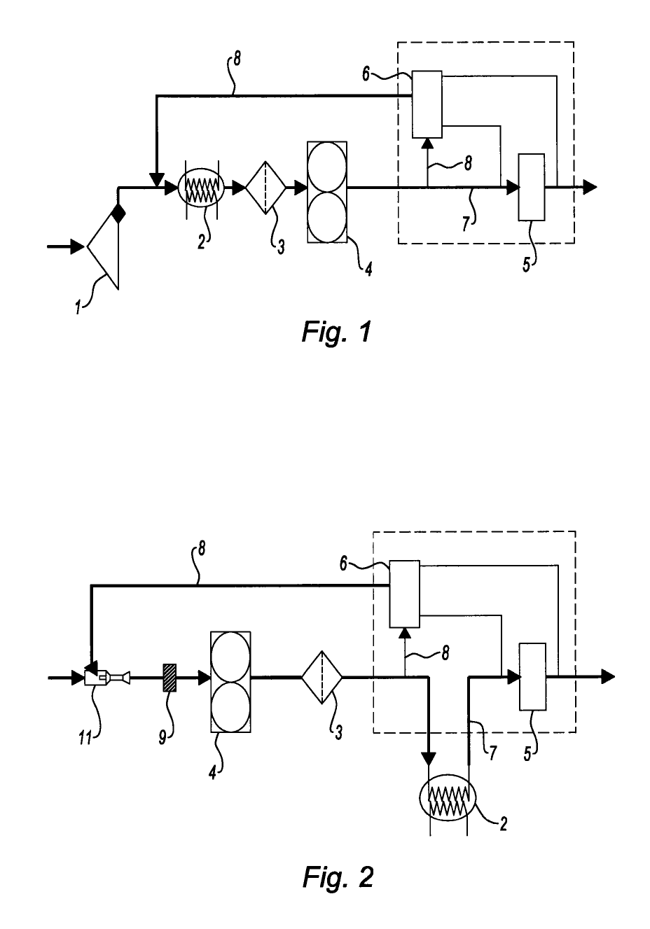

FIG. 1 is a schematic view of a fuel circuit for a turbine engine according to the prior art;

FIG. 2 is a schematic view of a fuel circuit for a turbine engine according to a first embodiment of the invention; and

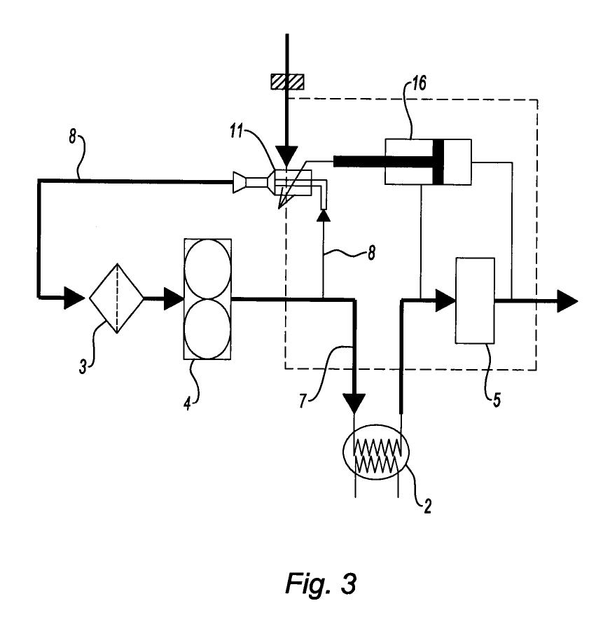

FIG. 3 is a schematic view of a fuel circuit for a turbine engine according to a second embodiment of the invention.

FIG. 1 shows the conventional fuel circuit of a turbine engine comprising, in the direction of flow of the fuel, a low pressure pump 1 which receives fuel from a tank of the aircraft, via an aircraft booster pump (not shown). On leaving the low pressure pump 1, the fuel passes through one or more heat exchangers 2 and through a main filter 3. This filter is conventionally associated with a branch circuit (not shown) including a check valve to prevent any clogging of the filter 3. On leaving the filter 3, the fuel enters a high pressure pump 4, of the constant flow volumetric type. This pump brings the fuel to a pressure at which it can be injected into the combustion chamber via appropriate injectors and can be vaporized in conditions suitable for its combustion.

Downstream of the HP pump 4, the fuel enters a hydraulic member for regulating the flow rate (shown in broken lines), comprising a metering device 5 and a regulating valve 6. The position of the metering device 5 is controlled in such a way that the desired flow is allowed to pass in response to a command from the pilot, in order to provide the desired thrust or power, depending on whether a turbojet or a turboshaft engine is being used. A branch is connected to the fuel supply circuit 7, and includes a regulating valve 6, which controls the excess flow branch. When the fuel flows in the regulating valve, its pressure is substantially brought to the level at which it entered said HP pump, and the branch circuit 8 sends the excess flow upstream of the HP pump 4 to the inlet of the exchanger 3, or to the inlet of the main filter 3, or directly to the inlet of the HP pump 4.

FIG. 1 also shows two conduits which sample the pressure upstream and downstream of the metering device, allowing the regulating valve 6 to control the flow regulation of the system by modulating the pressure difference around a constant value by modifying the fluid passage cross section.

Referring now to FIG. 2, this shows a fuel circuit according to a first version of the invention. This is similar to the preceding version in that it includes a low pressure pump 11, a main filter 3, one or more heat exchangers 4 and a flow rate regulation member comprising a metering device 5 and a regulating valve 6 which is actuated by conduits which, as before, sample the fuel pressure upstream and downstream of the metering device. By contrast with FIG. 1, in this case the main filter 3 is positioned downstream of the HP pump 4, although this positioning is not essential, since the pump can equally well be positioned in its former position, that is to say upstream of the HP pump. The main filter 3 is preferably positioned upstream of the HP pump 4 if the pressure level provided by the jet pump 11 is sufficient. If this is not the case, it is placed downstream of the HP pump, and a fine mesh screen 9 is used to protect said HP pump.

However, in the claimed invention, the heat exchanger or exchangers 2 are placed in the fuel circuit in the direct circuit 7, downstream of the HP pump and downstream of the fuel branching point. Additionally, the LP pump is a jet pump 11 whose driving fluid is the fuel returned through the branch circuit 8.

With reference to FIG. 3, a second embodiment will now be described. The elements of the fuel circuit which are identical to the first embodiment are indicated by the same reference numerals and are not described again. In this variant, the jet pump 11 is a jet pump with a variable cross section, in other words a pump whose inlet cross section can be modified, for example by the positioning of a float needle associated with a nozzle. The cross section of the jet pump can thus be adapted to the recirculated flow and the power recovery can be optimized in the great majority of cases of operation of the engine. In this variant, the regulating valve is eliminated and is replaced with a piston 16 which receives data on the pressure upstream and downstream of the metering device 5 and controls the variable cross section of the jet pump 11 in accordance with these data. The main filter 3 is preferably positioned upstream of the HP pump, the pressure provided by the jet pump being fixed at a sufficient level in this case as a result of its control by the piston 16.

The operation of the fuel circuit according to the first embodiment will now be described.

The fuel from the tank of the aircraft is drawn in by the jet pump 11 by means of the Venturi effect created in the pump by the recirculated fuel which arrives from the recirculation circuit 8. This fuel is at a higher pressure than the fuel entering the inlet jet of the jet pump, and is subjected to an acceleration in a suitable chamber where it undergoes a pressure drop which creates the Venturi effect. The fuel from the aircraft tank is then drawn in and mixed with the recirculation fuel, and when it leaves the LP pump it has been compressed to a pressure at which the HP pump is able to operate.

The fuel then flows into the HP pump 4 and through the main filter 3, and then enters the hydraulic flow regulation unit, where it is metered by the metering device 5. Only the fuel flowing in the direct circuit 7 is heated by the exchangers 2, which are positioned for this purpose downstream of the HP pump and downstream of the recirculation circuit branch. However, they are positioned upstream of the metering device 5 in order to avoid problems caused by the operation of the hydraulic unit in conditions of extreme cold.

The volume of fuel which is not to be injected into the combustion chamber is sent toward the upstream part of the fuel circuit via the recirculation circuit 8. Consequently it has not passed through the exchanger and therefore remains at a temperature close to that of the tanks; its saturated vapor pressure thus remains low enough to allow the correct operation of the jet pump 11.

The installation of this jet pump 11, which uses the power of the recirculated flow for its operation, makes it possible to eliminate the rotating parts (LP shafts, centrifugal impeller, hydrodynamic bearings) of conventional LP pumps and thus improve the reliability of the fuel circuit. Furthermore, the reduction in the number of parts has the effect of decreasing the overall weight of the fuel circuit.

The operation of the fuel circuit according to the second embodiment is identical. If a suitable principle is followed for the positioning of the piston 16, this version enables the operation of the jet pump 11 to be optimized at all the operating points of the engine, since the pump is required to operate over a wide range of flow rates and pressures. Thus the piston 16 is controlled so that the variable cross section of the inlet jet of the jet pump 11 is adapted at all times to the recirculated flow, and so that the recovery of the power of this flow is optimized for all operating points of the engine. The assembly formed by the piston 16 and the variable nozzle of the jet pump 11 acts as a regulating valve and allows the pressure difference to be kept approximately constant across the metering device. The pressures upstream and downstream of the metering device control the piston 16 which, by modifying the passage cross section of the jet pump, modulates the pressure difference about a constant value, and thus enables the flow of the system to be controlled.

Although the invention has been described with reference to a number of specific embodiments, it naturally comprises all the technical equivalents of the means described and their combinations where these fall within the scope of the invention.

1-7. (canceled)

8. An assembly for supplying a combustion chamber of a turbine engine with fuel and for pressurizing the fuel, comprising:
a first pump for pressurizing fuel drawn from tanks of an aircraft;
a second pump for raising the pressure above an outlet pressure of the first pump, the second pump being a constant fuel delivery pump, some of the fuel leaving the second pump being sent to the combustion chamber via a direct circuit, the part of the fuel that is not sent to the combustion chamber being recirculated via a recirculation circuit upstream of the second pump;
a hydraulic unit for metering flow to be injected into the combustion chamber of the turbine engine by a metering device located in the direct circuit, a regulating valve actuated by conduits that sample the fuel pressure upstream and downstream of the metering device, and at least one heat exchanger in which the fuel flows,
wherein the exchanger is positioned in a direct circuit downstream of a branching point of the recirculation circuit, upstream of the conduit for sampling the pressure upstream of the metering device, and upstream of the fuel metering device.

9. The assembly as claimed in claim 8, wherein the first pump is a jet pump that has no rotating parts.

10. The assembly as claimed in claim 9, wherein driving fluid of the jet pump is formed by the recirculated fuel.

11. The assembly as claimed in claim 9, wherein the first pump is a jet pump with a variable cross section.

12. The assembly as claimed in claim 11, wherein a size of the variable cross section is controlled by a piston whose position in its cylinder is a function of pressures in the fuel circuit immediately upstream and downstream of the metering device.

13. A turbine engine comprising a fuel supply and pressurization assembly according to claim 8.

14. An aircraft comprising at least one turbine engine as claimed in claim 13.
